(19) United States
(12) Patent Application Publication
(10) Pub. No.: US 2003/0091691 A1
(43) Pub. Date: May 15, 2003

(54) Stepping process

(76) Inventors: Hans Sejr Olsen, Holte (DK); Bjarne Ronfeldt Nielsen, Virum (DK)

Correspondence Address: NOVOZYMES NORTH AMERICA, INC., 500 FIFTH AVENUE, SUITE 1600, NEW YORK, NY, 10110, US

(21) Appl. No.: 10/312,356

(22) PCT Filed: Jun. 20, 2001
(86) PCT No.: PCT/DK01/00429

(30) Foreign Application Priority Data
Jun. 23, 2000 (DK) PA 2000 00982
Aug. 25, 2000 (DK) PA 2000 01263

(51) Int. Cl. A23K 1/00

(52) U.S. Cl. 426/49

(57) ABSTRACT

The present invention relates to an improved process of steeping crop kernels, comprising soaking the kernels in water for 1-48 hours, in the presence of selected enzymes.

### FIELD OF THE INVENTION

The present invention relates to an improved steeping process constituting the first step in the milling process of corn kernels and other crop kernels preparing starch to be suitable for the conversion of starch into mono- di-, oligosaccharides, ethanol, sweeteners etc.

Further the invention also relates to an enzyme composition comprising a cell wall degrading activity for use in a steeping process.

### BACKGROUND OF THE INVENTION

Before starch—being an important constituent in the kernels of most crops, such as corn, wheat, rice, sorghum bean, barley or fruit hulls—can be used for conversion of starch into saccharides, such as dextrose, fructose; alcohols, such as ethanol; and sweeteners, the starch must be made available and treated in an manner to provide a high purity starch. If starch contains more than 0.5% impurities, including proteins, it is not suitable as starting material for starch conversion processes. To provide such pure starch product staring out from the kernels of crops the kernels are often milled, as will be described further below.

The Composition of Corn Kernels

Corn kernels, such as the yellow dent corn kernel, have an outer covering referred to as the “Pericarp” that protects the germ in the kernels. It resists water and water vapour and is undesirable to insects and microorganisms.

The only area of the kernels not covered by the “Pericarp” is the “Tip Cap”, which is the attachment point of the kernel to the cob.

The “Germ” is the only living part of the corn kernel. It contains the essential genetic information, enzymes, vitamins, and minerals for the kernel to grow into a corn plant. About 25 percent of the germ is corn oil. The endosperm covered surrounded by the germ comprises about 82 percent of the kernel dry weight and is the source of energy (starch) and protein for the germinating seed. There are two types of endosperm, soft and hard. In the hard endosperm, starch is packed tightly together. In the soft endosperm, the starch is loose.

Wet milling

Wet milling is often used for separating corn kernels into its four basic components: starch, germ, fiber and protein.

Typically wet milling processes comprise four basic steps. First the kernels are steeped for 30 to 48 hours to begin breaking the starch and protein bonds. The next step in the process involves a coarse grind to separate the germ from the rest of the kernel. The remaining slurry consisting of fiber, starch and protein is finely ground and screened to separate the fiber from the starch and protein. The starch is separated from the remaining slurry in hydrocyclones. The starch then can be converted to syrup or alcohol.

Today enzymes are not commonly for the first step in the wet milling process namely the steeping step, wherein the kernels are softened. However, the use of enzymes for the steeping step has been suggested. The enzyme Steepzyme® (available from Novozymes A/S) have been shown suitable for steeping of corn. However, there is a need for further improvement of enzyme compositions for steeping. There is still a need for improving the milling process steps including the steeping, starch gluten separation, and starch-washing steps.

Accordingly, the object of the invention is to provide an improved milling process. More specifically it is the object of the invention to provide an improved steep process.

### BRIEF DESCRIPTION OF THE DRAWINGS

FIG. 1 shows a corn wet milling process,

FIG. 2 shows the processes used in a corn steeping plant in a schematic form.

### DETAILED DESCRIPTION OF THE INVENTION

The object of the present invention is to improve the steeping process step of wet milling processes, where kernels of crops, such as especially corn, are separated into the four main constituents: starch, germ, fiber and protein.

The Milling Process

The kernels are milled in order to open up the structure and to allow further processing. Two processes are used: wet or dry milling. In dry milling processes the whole kernels are milled and used in the remaining part of the process. Wet milling gives a very good separation of germ and meal (starch granules and protein) and is often applied at locations where there is a parallel production of syrups.

Degradation of Crops into Starch Suitable for Conversion

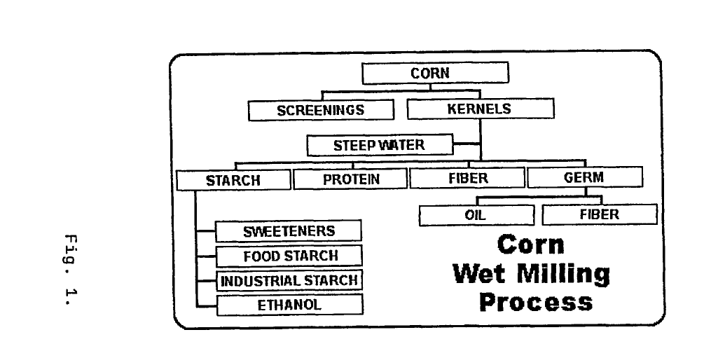

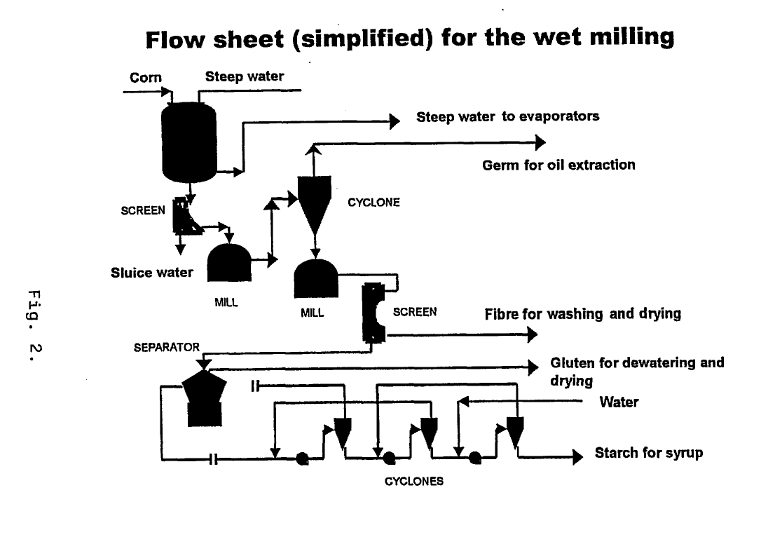

Degradation of the kernels of corn (see also FIG. 1 and FIG. 2) and other crop kernels into starch suitable for conversion of starch into mono-, di-, oligo saccharides, ethanol, sweeteners etc. consists of four steps:

1. Steeping and germ separation,

2. Fiber washing and drying,

3. Starch gluten separation,

4. Starch washing.

1. Steeping and Germ Separation

Corn kernels are softened by soaking in water for between 30 and 48 hours at a temperature about 50° C. During steeping, the kernels absorb water, increasing their moisture levels from 15 percent to 45 percent and more than doubling in size. The addition of 0.1% sulfur dioxide (SO₂) and/or NaHSO₃ to the water prevents excessive bacteria growth in the warm environment. As the corn swells and softens, the mild acidity of the steepwater begins to loosen the gluten bonds within the corn and release the starch. After the corn kernels are steeped they are cracked open to release the germ. The germ contains the valuable corn oil. The germ is separated from the heavier density mixture of starch, hulls and fiber essentially by “floating” the germ segment free of the other substances under closely controlled conditions. This method serves to eliminate any adverse effect of traces of corn oil in later processing steps.

2. Fiber Washing and Drying

To get maximum starch recovery, while keeping any fiber in the final product to an absolute minimum, it is necessary to wash the free starch from the fiber during processing. The fiber is collected, slurried and screened to reclaim any residual starch or protein.

3. Starch Separation

The starch-gluten suspension from the fiber-washing step, called mill starch, is separated into starch and gluten. Gluten has a low density compared to starch. By passing mill starch through a centrifuge, the gluten is readily spun out.

4. Starch Washing.

The starch slurry from the starch separation step contains some insoluble protein and much of solubles. They have to be removed before a top quality starch (high purity starch) can be made. The starch, with just one or two percent protein remaining, is diluted, washed 8 to 14 times, re-diluted and washed again in hydroclones to remove the last trace of protein and produce high quality starch, typically more than 99.5 percent pure.

Process of the Invention

The inventors of the present invention have surprisingly found that selected enzyme activities and combinations thereof may be used to improve steeping of kernels of crops, in particular corn. The steeping time may be reduced to between 1 and 48 hours, preferably 3-40 hours, in particular 5-24 hours and consequently less energy is used. Other advantages may be that the amount of chemicals, such as SO₂ and NaHSO₃, which need to be used, may be reduced or even fully removed. Further, the final starch yields may also be increased.

In the first aspect the invention relates to a process of steeping crop kernels, comprising soaking the kernels in water for 1-48 hours, in the presence of a xylanase in an effective amount.

The xylanase may be added in an amount of 1-100 FXU, preferably 5-90 FXU, especially 10-80 FXU per 100 g DS kernels. In an embodiment of the invention a cellulase is added or present during steeping in an effective amount.

The cellulase may be added in an amount of 1-1000 NCU, preferably 170-900 NCU, especially 200-800 NCU per 100 g DS kernels.

Also an arabinofuranosidase may be added or present during steeping in an effective amount.

The invention also relates to a process of steeping crop kernels, comprising soaking the kernels in water for 1-48 hours, in the presence of a cellulase in an effective amount.

The cellulase may be added in an amount of 1-1,000 NCU, preferably 170-900 NCU, especially 200 to 800 NCU per 100 g DS kernels.

In an embodiment of the invention a xylanase may be added or present during steeping in an effective amount.

The xylanase may be added in an amount of 1-100 FXU, preferably 5-90 FXU, especially 10 to 80 FXU per 100 g DS kernels. According to the invention an arabinofuranosidase may also be added or present during steeping in an effective amount.

The invention also relates to a process of steeping crop kernels, comprising soaking the kernels in water for 1-48 hours, in the presence of an arabinofuranosidase in an effective amount.

In an embodiment of the invention a cellulase may also be added or present during steeping in an effective amount.

The cellulase may be added in an amount of 1-1,000 NCU, preferably 170-900 NCU, especially 200 to 800 NCU per 100 g DS kernels.

According to the invention a xylanase may also be added or present during steeping in an effective amount. The xylanase may be added in an amount of 1-100 FXU, preferably 5-90 FXU, especially 10 to 80 FXU per 100 g DS kernels.

In an embodiment of the invention an acidic protease may be added or present during steeping in an effective amount. The acidic protease may be added in an amount of 1-10,000 HUT/100 g DS kernels, preferably 300-8,000 HUT/100 g DS kernels, especially 3,000-6,000 HUT/100 g DS kernels.

In an embodiment the invention relates to a steeping process comprising soaking the kernels in the presence of an effective amount of lipolytic enzyme for 1-48 hours.

The term “lipolytic enzyme” includes enzymes with lipase and/or cutinase activity.

The lipolytic enzyme is normally added or present in an amount of 0.001-1% lipolytic enzyme protein/100 g DS kernels.

In a preferred embodiment one or more of the following enzyme activities are also added or present during steeping: Cellulase, xylanase, acidic protease, arabinofurosidase.

Additionally one or more of the following enzyme activities may be added or present during steeping in effective amounts: endoglucanase, beta-glucanase, pentosanase, and pectinase.

It is believed that the enzyme(s) penetrate(s) into the kernels, causing a degradation of the internal cell wall and the protein matrix of the whole kernel. Thereby the starch is washed out more easily in the subsequent steps.

The steeping process of the invention may be performed at a temperature in the range between 40 and 60° C., preferably around 50° C.

In an embodiment the steeping is performed in the presence of 0.01-1%, preferably 0.05-0.3%, especially 0.1-0.2% SO₂ and/or NaHSO₃.

When using the term “kernels” it is intended to include kernels from corn (maize), rice, barley, sorghum bean, or fruit hulls, or wheat.

The above enzyme activities may be any of the below mentioned

In a preferred embodiment xylanase and/or cellulase and/or arabinofuranosidase and/or acidic protease is derived from the genus Aspergillus, preferably A. aculeatus, especially A. aculeatus CBS 101.43.

Further also contemplated according to the invention are any enzyme activities comprised in Steepzyme®.

In a preferred embodiment any of the processes of the invention are performed in the presence of Steepzyme® enriched with one or more of the following activities: xylanase, cellulase, arabinofuranosidase, endoglucanase, beta-glucanase, pentosanase, pectinase and/or acidic protease activity.

Especially preferred are processes performed in the presence of the acidic protease I derived from A. aculeatus CBS 101.43 in an effective amount.

The kernels are subjected to the 0.01-1%, preferably 0.05-0.2%, especially 0.1% (w/w) of the kernels Steepzyme® enriched to provide a total HUT/100 g DS kernels from 4,000-20,000 HUT/100 g DS kernels acidic protease, preferably 5,000-10,000 HUT/100 g, especially from 6,000-16,500 HUT/g DS kernels.

In a preferred embodiment the acidic protease is an aspartic protease, such as an aspartic protease derived from a strain of Aspergillus, in particular A. aculeatus, especially A. aculeatus CBD 101.43.

Preferred are aspartic proteases, which retain activity in the presence of an inhibitor selected from the group consisting of pepstatin, Pefabloc, PMSF, or EDTA. Protease I derived from A. aculeatus CBS 101.43 is such acidic protease.

In the context of the present invention, the term “enriched” is intended to indicate that the enzyme activity in question of the enzyme preparation has been increased, e.g., with an enrichment factor of at least 1.1, conveniently due to addition of a recombinant mono-component enzyme.

The below enzyme may also be used according to the invention.

Acidic Proteases

Suitable acidic proteases include fungal and bacterial proteases, i.e., proteases characterized by the ability to hydrolyze proteins under acidic conditions below pH 7.

Suitable acid fungal proteases include fungal proteases derived from Aspergillus, Mucor, Rhizopus, Candida, Coriolus, Endothia, Enthomophtra, Irpex, Penicillium, Sclerotium and Torulopsis. Especially contemplated are proteases derived from Aspergillus niger (see, e.g., Koaze et al., (1964), Agr. Biol. Chem. Japan, 28, 216), Aspergillus saitoi (see, e.g., Yoshida, (1954) J. Agr. Chem. Soc. Japan, 28, 66), Aspergillus awamori (Hayashida et al., (1977) Agric. Biol. Chem., 42(5), 927-933, Aspergillus aculeatus (WO 95/02044), or Aspergillus oryzae; and acidic proteases from Mucor pusillus or Mucor miehei.

In an embodiment the acidic protease is a protease clomplex from A. oryzae sold under the tradename Flavourzyme® (from Novozymes A/S) or an aspartic protease from Rhizomucor miehei or Spezyme® FAN or GC 106 from Genencor Int.

Xylanases

The xylanase activity may be derived from any suitable organism, including fungal and bacterial organisms, such as Aspergillus, Disporotrichum, Penicillium, Neurospora, Fusarium and Trichoderma.

Examples of suitable xylanases include xylanases derived from H. insolens (WO 92/17573; Aspergillus tubigensis (WO 92/01793); A. niger (Shei et al., 1985, Biotech. and Bioeng. Vol. XXVII, pp. 533-538, and Fournier et al., 1985, Biotech. Bioeng. Vol. XXVII, pp. 539-546; WO 91/19782 and EP 463 706); A. aculeatus (WO 94/21785).

In a specific embodiment the xylanase is Xylanase II disclosed in WO 94/21785.

Contemplated commercially available xylanase include Shearzyme®, Biofeed wheat® (from Novozymes A/S) and Spezyme® CP (from Genencor Int.).

Cellulases

The cellulase may be of microbial origin, such as derivable from a strain of a filamentous fungus (e.g., Aspergillus, Trichoderma, Humicola, Fusarium). Specific examples of cellulases include the endo-glucanase (endo-glucanase I) obtainable from H. insolens and further defined by the amino acid sequence of FIG. 14 in WO 91/17244 and the 43 kD H. insolens endoglucanase described in WO 91/17243.

Commercially available cellulase which may be used include Celluclast®, Celluzyme® (available from Novozymes A/S), Spezyme® CP (available from Genencor Int.) and Rohament® 7069 W (available from Röhm, Germany).

Arabinofuranosidases

Examples of contemplated arabinofuranosidases include A. niger alpha-L-arabinofuranosidase A and B disclosed in WO 97/42301; the Aspergillus sp. arabinofuranosidase disclosed in EP 871,745; the Aspergillus niger K1 alpha-L-arabinofuranosidase disclosed in DD 143925.

Lipolytic Enzymes

It is believed that lipases and/or cutinases are capable of degrading the tip cap of the kernels and this way speed up the soaking and thus the steep process.

Cutinases

Cutinases are known from various fungi (P. E. Kolattukudy in “Lipases”, Ed. B. Borgstrom and H. L. Brockman, Elsevier 1984, 471-504). The Fusarium solani pisi cutinase has been described in S. Longhi et al., Journal of Molecular Biology, 268 (4), 779-799 (1997)) and WO 90/09446).

The amino acid sequence of a cutinase from Humicola insolens has also been published (U.S. Pat. No. 5,827,719). The H. insolens strain DSM 1800 cutinase is shown as SEQ ID NO: 2 and SEQ ID NO: 1 of U.S. Pat. No. 5,827,719. The F. solani pisi cutinase is shown as the mature peptide in FIG. 1D of WO 94/14964. A Pseudomonas mendocina cutinase is described in WO 88/09367. A number of variants of the cutinase of Fusarium solani pisi have been published: WO 94/14963; WO 94/14964; WO 00/05389; Appl. Envirorm. Microbiol. 64, 2794-2799, 1998; Proteins: Structure, Function and Genetics 26, 442-458, 1996; J. of Computational Chemistry 17, 1783-1803, 1996; Protein Engineering 6, 157-165, 1993; Proteins: Structure, Function, and Genetics 33, 253-264, 1998; J. of Biotechnology 66, 11-26, 1998; Biochemistry 35, 398-410, 1996; Chemistry and Physics of Lipids 97, 181-191, 1999; Proteins: Structure, Function, and Genetics 31, 320-333, 1998; Biochimica et Biophysica Acta 1441, 185-196, 1999; Appl. Environm. Microbiol. 64, 316-324, 1998; BioTechniques 27, 1102-1108, 1999.

Preferred cutinises are: Fusarium solani pissi cutinase, Humicola insolens cutinase and thermostable mutants of Humicola insolens cutinase JCO39, JC0456, JC0492; FL34; Aspergillus oryzae cutinase.

Lipases

Examples of lipases include a Humicola lanuginosa lipase, e.g., described in EP 258 068 and EP 305 216, a Rhizomucor miehei lipase, e.g. as described in EP 238 023, Absidia sp. lipolytic enzymes (WO 96/13578), a Candida lipase, such as a C. antarctica lipase, e.g., the C. antarctica lipase A or B described in EP 214 761, a Pseudomonas lipase such as a P. alcaligenes and P. pseudoalcaligenes lipase, e.g. as described in EP 218 272, a P. cepacia lipase, e.g. as described in EP 331 376, a Pseudomonas sp. lipase as disclosed in WO95/14783, a Bacillus lipase, e.g. a B. subtilis lipase (Dartois et al., (1993) Biochemica et Biophysica acta 1131, 253-260), a B. stearothermophilus lipase (JP 64/744992) and a B. pumilus lipase (WO 91/16422).

Furthermore, a number of cloned lipases have been described, including the Penicillium camembertii lipase described by Yamaguchi et al., (1991), Gene 103, 61-67), the Geotricum candidum lipase (Schimada, Y. et al., (1989), J. Biochem., 106, 383-388), and various Rhizopus lipases such as a R. delemar lipase (Hass, M. J et al., (1991), Gene 109, 117-113) a R. niveus lipase (Kugimiya et al., (1992), Biosci. Biotech. Biochem. 56, 716-719) and a R. oryzae lipase.

Preferred lipases include the Humicola lanuginose lipase and variants thereof, such as Humicola lanuginose lipase variant HL1232, and the Fusarium oxysporum lipase.

Steeping Composition

The invention also relates to an enzyme composition. For steeping the composition may comprise a single enzyme activity or a combination of enzyme activities.

An object of the invention is to provide a composition suitable for steeping comprising one or more of the following enzyme activities: endoglucanase, beta-glucanase, xylanase, cellulase, pentosanase, pectinase, arabinofurasidase and/or acidic protease activity.

In an embodiment the composition comprise xylanase and acidic protease activity. The composition may further comprise arabinofurasidase and/or cellulase activity.

In another embodiment the composition of the invention comprises cellulase and acidic protease activity. The composition may further comprise arabinofurasidase and/or xylanase activity.

In a further embodiment the composition of the invention comprises arabinofurosidase and acidic protease activity. The composition may further comprise cellulase and/or xylanase activity.

In preferred embodiment the composition of the invention is Steepzyme® (available from Novozymes A/S) enriched with a cellulase and/or xylanase and/or arabinofuranosidase and/or an acidic protease. The composition may comprise more than 3740 HUT/g enzyme, more than 45 FXU/g, more than 1694 NCU/g.

Preparation of Steepzyme®

Steepzyme® is a liquid plant cell wall degrading enzyme preparation prepared from Aspergillus aculeatus CBS 101.43, publicly available from the Centraalbureau voor Schimmelcultures, Delft, NL. Steepzyme® comprises a number of enzyme activities, including endoglucanase activity (about 585 EGA/g); fungal beta-glucanase activity (about 187 FBG/g); Fungal xylanase activity (45 FXU/g); acidic protease activity (3,740 HUT/g); cellulase l,694/g); pentosanase activity (77 PTU/g); pectinase activity (18,700 PSU/g). The production of the Steepzyme® enzyme mixture is described in U.S. Pat. No. 4,478,939.

The steeping enzyme composition of the invention may in an embodiment comprise one or more of the above mentioned mono-components activities constituting Steepzyme® enriched with a dosage of more than 3740 EXU/g acidic protease activity (3740 HUT/g is the HUT/g activity of Steepzyme®); preferably enriched with between 1 and 20,000 HUT/g, more preferred 500 and 16,000 HUT/g, even more preferred 6,000 to 16,000 HUT/g acidic protease activity.

Use of a Composition of the Invention

A composition of the invention may be used for steeping crops, including corn, by addition to the steepwater in an effective amount. In an embodiment the composition of the invention may be used in connection with carrying out the process of the invention by addition to the steepwater in a concentration of 0.1% Steepzyme® enriched with acidic protease so that the steepwater comprises a total of from 4,000-20,000 HUT/100 g DS corn or kernels of other crops. In a preferred embodiment the steepwater comprises in the range of between 500-16,000 HUT/100 g DS corn, especially in the range between 6,500-10,000 HUT/100 g DS corn in the steepwater.

Materials & Methods

Enzymes:

Steepzyme®: multi activity enzyme complex derived from A. aculeatus 101.43 (is available from Novozymes A/S on request)

Shearzyme®: A. aculeatus CBS 101.43 xylanase II disclosed in WO 94/21785 (is available from Novozymes A/S)

Flavourzyme®: multi proteolytic activity enzyme complex derived from A. oryzae (is available from Novozymes A/S)

Protease I: acidic protease from Aspergillus aculeatus CBS 101.43 (disclosed in WO 95/02044)

Methods

Determination of Protease HUT Activity:

The HUT activity was determined according to the AF92/2 method published by Novozymes A/S, Denmark. 1 HUT is the amount of enzyme which, at 40° C. and pH 4.7 over 30 minutes forms a hydrolysate from digesting denatured hemoglobin equivalent in absorbancy at 275 nm to a solution of 1.10 μg/ml tyrosine in 0.006 N HCl which absorbancy is 0.0084. The denatured hemoglobin substrate is digested by the enzyme in a 0.5 M acetate buffer at the given conditions. Undigested hemoglobin is precipitated with trichloroacetic acid and the absorbance at 275 nm is measured of the hydrolysate in the supernatant.

Determination of Xylanase Activity (FXU)

The endo-xylanase activity is determined by an assay, in which the xylanase sample is incubated with a remazol-xylan substrate (4-O-methyl-D-glucurono-D-xylan dyed with Remazol Brilliant Blue R, Fluka), pH 6.0. The incubation is performed at 50° C. for 30 min. The background of non-degraded dyed substrate is precipitated by ethanol. The remaining blue colour in the supernatant is determined spectrophotometrically at 585 nm and is proportional to the endoxylanase activity.

The endoxylanase activity of the sample is determined relatively to an enzyme standard.

The assay is further described in the publication AF 293.6/1-GB, available upon request from Novozymes A/S, Denmark.

Determination of Endo-Glucanase Units (ECU)

The ECU (endocellulose unit) is determined relatively to an enzyme standard.

Endocellulase decomposes carboxylmethylcellulose, CMC. The resulting reduction in viscosity is determined by a CMC-vibration Viscosimeter (e.g. MIVI 3000 available from Sofraser, France).

The prepared substrate solution contain 35 g/l CMC (Blanose Aqualon) in 0.1 M phosphate buffer at pH 7.5. The enzyme sample to be analyzed is determined is dissolved in the same buffer.

0.15 ml standard enzyme solution or the unknown enzyme sample is placed in 10 ml test tubes. 5 ml CMC-substrate solution, preheated to 40° C., is added. The joint solution is mixed thoroughly, incubated for 30 minutes and placed in the viscometer.

The method is further described in AF302/1-GB available from Novozymes A/S upon request.

Determination of Endo-Glucanase Activity (EGU)

The fermentation broths are analyzed by vibration viscosimetry on CMC at pH 6.0. More specifically, a substrate solution containing 34.0 g/l CMC (Blanose Aqualon) in 0.1 M phosphate buffer, pH 6.0 is prepared. The enzyme sample to be analyzed is dissolved in the same buffer. 14 ml substrate solution and 0.5 ml enzyme solution are mixed and transferred to a vibration viscosimeter (e.g. MIVI 3000 available from Sofraser, France) thermostated at 40° C. Endoglucanase unit (EGU) is determined as the ratio between the viscosity of the sample and the viscosity of a standard enzyme solution.

Cellulytic Activity

The cellulytic activity is determined with carboxymethyl cellulose (CMC) as substrate.

One Novo Cellulase Unit (NCU) is defined as the amount of enzyme which, under standard conditions (i.e. at pH 4.80; 0.1 M acetate buffer; 10 g/l Hercules CMC type 7 LFD as substrate; an incubation temp. of 40.0° C.; an incubation time of 20 min; and an enzyme concentration of approximately 0.041 NCU/ml) forms an amount of reducing carbohydrates equivalent to 1 micro mol glucose per minute. A folder AF 187.2/1 describing this analytical method in more detail is available upon request to Novozymes A/S, Denmark, which folder is hereby included by reference.

Arabinofuranosidase Assay

The synthetic substrate p-nitrophenyl alpha-L-arabinofuranoside (SIGMA) is used as substate. Following cleavage of the enzyme, the p-nitrophenyl molecule is liberated and the development in yellow colour can be measured by visible spectrometty at 405 nm.

Stock solution: 1 mg/ml p-nitrophenyl alpha-L-arabinofuranoside in DMSO.

Substrate solution: 0.2 mg/ml p-nitrophenyl alpha-L-arabinofuranoside diluted in 50 mM Sodium acetate, pH 4.5.

Procedure: 100 microlitre enzyme and 100 microlitre is mixed in a 96-well plate and the development of yellow colour due to the enzymatic reaction is measured from 0 to 15 minutes at 405 nm. The slope of the time dependent OD405 curve is directly proportional to the amount of alpha-arabinofuranosidase.

Lipase (Cutinase) Activity (LU)

A substrate for lipase is prepared by emulsifying tributyrin (glycerin tributyrate) using gum Arabic as emulsifier. The hydrolysis of tributyrin at 30° C. at pH 7 is followed in a pH-stat titration experiment. One unit of lipase activity (1 LU) equals the amount of enzyme capable of releasing 1 micro mol butyric acid/min at the standard conditions.

### EXAMPLE 1

Steeping Trials:

The 100 g scale steeping procedure described by Eckhoff S R et.al. in Cereal Chemistry, 73 (1) 54-57 1996 has been used. The enzymes tested were Steepzyme, and Steepzyme+Protease I.

The steeping temperature was 50° C., the pH was pH=4-5. The SO₂ dosage was kept on 0.1%. Steeping time should be 24 hours for the samples including a blank. The enzyme was added after 2 or 3 hours, when pH is in the interval of 4 to 5.

Results:

The 100 g steeping trials have shown that the starch yields improved by use of Steepzyme+Protease I at both 12 hours and 24 hours steeping time. Furthermore the gluten yields improved by enzymatic steepings. There were indications that the main enzyme effects were during the milling and separation steps. Dosage response trials showed that the steeping time could be reduced from 48 hours (classical steeping) to about 12 hours.

1. A process of steeping crop kernels, comprising soaking the kernels in water for 1-48 hours, in the presence of a xylanase.

2. The process of claim 1, wherein the xylanase is added in an amount of 1-100, preferably 5-90, especially 10 to 80 FXU per 100 g kernels.

3. The process of claim 1, wherein also a cellulase is added.

4. The process of claim 3, wherein the cellulase is added in an amount of 1-1000, preferably 170-900, especially 200 to 800 NCU per 100 g kernels.

5. The process of claims 1-4, wherein also an arabinofuranosidase is added.

6. A process of steeping crop kernels, comprising soaking the kernels in water for 1-48 hours, in the presence of a cellulase.

7. The process of claim 6, wherein the cellulase is added in an amount of 1-1,000, preferably 170-900, especially 200 to 800 NCU per 100 g kernels.

8. The process of claim 6, wherein also a xylanase is added.

9. The process of claim 8, wherein the xylanase is added in an amount of 1-100, preferably 5-90, especially 10 to 80 FXU per 100 g kernels.

10. The process of claims 1 or 2, wherein also an arabinofuranosidase is present.

11. A process of steeping crop kernels, comprising soaking the kernels in water for 1-48 hours, in the presence of an arabinofuranosidase.

12. The process of claim 1, wherein also a cellulase is added.

13. The process of claim 6, wherein the cellulase is added in an amount of 1-1000, preferably 170-900, especially 200 to 800 NCU per 100 g kernels.

14. The process of claims 1 or 2, wherein also a xylanase is added.

15. The process of claim 1, wherein the xylanase is added in an amount of 1-100, preferably 5-90, especially 10 to 80 FXU per 100 g kernels.

16. The process of claims 1-15, wherein also an acidic protease is added.

17. The process of claim 16, wherein the acidic protease is added in an amount of 1-10,000 HUT/100 g kernels, preferably 300-8,000 HUT/100 g kernels, especially 3,000-6,000 HUT/100 g kernels.

18. A process of steeping crop kernels, comprising soaking the kernels in water for 1-48 hours, in the presence of an effective amount of a lipolytic enzyme, in particular lipase or cutinase.

19. The process according to claim 18, wherein further one or more of the following activities are present: xylanase, acidic protease, cellulase, and/or arabinofurasidase, or mixtures thereof.

20. The process of claim 1-19, wherein further one or more of the following enzyme activities are added: endoglucanase, beta-glucanase, pentosanase, pectinase, arabinanase, and/or xyloglucanase.

21. A process of claims 1-20, wherein the steeping is carried out at a temperature between 40 and 60° C., preferably around 50° C.

22. The process of claims 1-21, wherein the treatment is performed in the presence of 0.01-1%, preferably 0.05-0.3%, especially 0.1% SO₂ and/or NaHSO₃.

23. The process of claims 1-22, wherein the crop kernels are from corn, rice, barley, sorghum bean, fruit hulls, or wheat.

24. The process of claims 1-23, wherein the xylanase, and/or cellulase, arabinofurasidase and/or acidic protease is derived from the genus Aspergillus, preferably A. aculeatus, especially A. aculeatus CBS 101.43.

25. The process of claims 1-24, wherein the enzyme activities is derived from Steepzyme® enriched with one or more of the following activities: xylanase, cellulase, arabinosidase, endoglucanase, beta-glucanase, pentosanase, pectinase and/or acidic protease activity.

26. The process of claim 25, wherein the acidic protease is protease I derived from A. aculeatus CBS 101.43.

27. The process of claims 1-26, wherein the kernels are subjected to the Steepzyme® enzyme activities enriched to provide a total HUT/100 g DS kernels from 4,000-20,000 HUT/100 g DS kernels acidic protease, preferably 5,000-10,000 HUT/100 g, especially from 6,000-16,500 HUT/g DS kernels.

28. The process of claims 24 or 26 or 27, wherein the acidic protease is an aspartic protease, such as an aspartic protease derived from a strain of Aspergillus, in particular A. aculeatus, especially A. aculeatus CBD 101.43.

29. The process of claim 24, 26-28, wherein the aspartic protease retains activity in the presence of an inhibitor selected from the group consisting of pepstatin, Pefabloc, PMSF, and EDTA.

30. The process of claim 24, 26-28, wherein the protease is Protease I derived from A. aculeatus CBS 101.43.

31. A composition comprising one or more of the following enzyme activities: endoglucanase, beta-glucanase, xylanase, cellulase, pentosanase, pectinase, arabinofurasidase arabinanase, xyloglucanase and/or acidic protease activity.

32. The composition of claim 31 comprising a xylanase and an acidic protease activity.

33. The composition of claim 32, wherein the composition further comprises arabinofurasidase and/or cellulase activity.

34. The composition of claim 31 comprising a cellulase and an acidic protease activity.

35. The composition of claim 34, wherein the composition further comprises arabinofurasidase and/or xylanase activity.

36. The composition of claim 31 comprising arabinofurosidase and acidic protease activities.

37. The composition of claim 34, wherein the composition further comprises cellulase and/or xylanase activity.

38. The composition of claim 31-37, wherein the composition is Steepzyme® enriched with a cellulase and/or xylanase and/or arabinofuranosidase and/or an acidic protease.

39. The composition of claim 31-38, comprising more that 3740 HUT/g.

40. The composition of claim 31-39, comprising more that 45 FXU/g.

41. The composition of claim 31-40, comprising more that 1694 NCU/g.

42. Use of a composition of claims 31-41 for steeping kernels.

43. Use of claim 42, for corn or sorghum steeping.
